(19) United States
(12) Patent Application Publication
(10) Pub. No.: US 2004/0166049 A1
(43) Pub. Date: Aug. 26, 2004

(54) Method for controlling the expansion properties of thermally expandable sulfuric acid-graphite particles and their use

(76) Inventors: Arne Reinheimer, Zellerberg (DE); Antje Wenzel, Hofstetten (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/728,255

(22) Filed: Dec. 4, 2003

(30) Foreign Application Priority Data
Dec. 5, 2002 (DE) 102 56 963.0

(51) Int. Cl. C01B 31/04

(52) U.S. Cl. 423/448

(57) ABSTRACT

A method is described for controlling the expansion properties of thermally expandable sulfuric acid-graphite particles, wherein the sulfuric acid-graphite particles, produced by the reaction of graphite particles with sulfuric acid in the presence of an oxidizing agent, are washed with an aqueous washing liquid, containing the compounds affecting the expansion properties, to a pH ranging from 2 to 8 and preferably from 3 to 7, measured in the washing liquid separated from the washed sulfuric acid-graphite particles, and then dried. Furthermore, the use of the thermally expandable sulfuric acid-graphite particles, obtainable by the method of claims 1 to 9, as intumescing fire-retarding additives for producing fire-retarding compositions especially for the fire-preventing sealing of through holes, wall bushings and other openings in walls, floors and/or ceilings of buildings, is described.

### FIELD OF INVENTION

The present invention relates to a method for controlling the expansion properties of thermally expandable sulfuric acid-graphite particles and the use of the sulfuric acid-graphite particles, obtained in this way, as intumescing flame-retarding additives for producing flame-retarding compositions, for example, for the fire-preventing sealing of through holes, wall bushings and other openings in walls, floors and/or ceilings of buildings.

### BACKGROUND INFORMATION AND PRIOR ART

Thermally expandable sulfuric acid-graphite particles or particulate, thermally expandable sulfuric acid-graphite is also known as expandable graphite and is commercially available. These particles, each contain foreign components (intercalates) intercalated between lattice layers of the crystalline graphite. Such expandable graphite intercalation compounds usually are produced by dispersing graphite particles in a solution, which contains an oxidizing agent and the guest compound, which is to be intercalated. Usually, nitric acid, potassium chlorate, chromic acid, potassium permanganate and the like are used as oxidizing agent. In the case of sulfuric acid-graphite particles, concentrated sulfuric acid is used as the compound, which is to be intercalated.

A method for producing such sulfuric acid-graphite particles is already known, for example, from the U.S. Pat. No. 4,091,083 and consists therein that crystalline graphite particles are dispersed in sulfuric acid, the mixture is stirred with the addition of hydrogen peroxide and the stirring is continued until the sulfuric acid has been intercalated in the graphite. Subsequently, the excess acid is separated, the remaining acid, present in the solid product, is removed by repeated washing with water and the material is dried.

When heated to a temperature above the so-called onset temperature, the graphite intercalation compounds and, with that, also sulfuric acid-graphite particles undergo a large increase in volume with expansion factors of more than 200. This increase in volume is caused by the fact that the intercalation compound, intercalated in the layered structure of the graphite, is decomposed with the formation of gaseous materials, so that the graphite particles are expanded perpendicular to the plane of the layers. This expansion behavior is utilized, for example, in intumescing compositions, which are used, in particular, for the flame-retarding sealing of cable and pipe bushings through walls and ceilings of buildings. In the event of a fire, once the onset temperature has been reached, the graphite particles and, with that, the intumescing composition sealing the wall bushing, expand so that, even after the insulation of the cables, passed through the wall bushing, and/or the plastic pipes have been burned away, the fire is prevented or retarded from breaking through the wall bushing.

The onset temperature is defined as the temperature, at which the thermal expansion process of the intumescing system, that is, in this case, of the thermally expandable sulfuric acid-graphite particles, commences. In other words, it is the temperature at the start of the expansion process. The conventional and commercially obtainable expanding graphite types have only very limited onset temperatures of about 150° C., about 160° C. and about 200° C. Moreover, they are fixed with regard to their expansion properties, that is, with regard to the expansion volume, the expansion rate in the region of the onset, the temperatures at which a percentage of the maximum expansion volume is attained and the average coefficient of expansion.

However, there is a great need for being able to influence these expansion properties of thermally expandable graphite particles in order to be able to adapt them better to the properties aimed for in the case of the special application, particularly for the use of such graphite particles as intumescing fire-retarding additives for producing fire-retarding compositions. For this application, it would be desirable to make possible selectively a greater range of variations of the expansion properties of such graphite particles, which have been addressed above.

### OBJECT OF THE INVENTION

The object of the present invention therefore consists of indicating a method, with which it becomes possible to influence the expansion properties of thermally expandable sulfuric acid-graphite particles selectively and easily, particularly with respect to the expansion volume, the expansion rate and the average expansion coefficient.

### SUMMARY OF THE INVENTION

Surprisingly, it has turned out that this objective can be achieved owing to the fact that the expansion behavior can be affected selectively by washing the sulfuric acid-graphite particles, produced by the reaction of graphite particles with sulfuric acid in the presence of an oxidizing agent, with an aqueous washing liquid, which contains certain compounds, which affect the expansion properties.

Accordingly, the objective named above is accomplished by the method of the main claim. The dependent claims relate to the preferred embodiment of this inventive object as well as to the use of thermally expandable sulfuric acid-graphite particles, obtainable with the help of this method, as intumescing fire-retarding additive for producing fire-retarding compositions, particularly intumescing compositions, for example, for the fire-preventing sealing of through holes, wall bushings and other openings in walls, floors and/or ceilings of buildings.

The present invention therefore relates to a method for controlling the expansion properties of thermally expandable sulfuric acid-graphite particles, which is wherein the sulfuric acid-graphite particles, produced by the reaction of graphite particles with sulfuric acid in the presence of an oxidizing agent, are washed with an aqueous washing liquid, containing compounds, which affect the expansion property, to a pH ranging from 2 to 8 and preferably from 3 to 7, measured in the washing liquid removed from the washed sulfuric acid-graphite particles, after which the latter are dried.

Preferably, for the preparation of the sulfuric acid-graphite particles, a ratio of sulfuric acid to oxidizing agent ranging from 200:1 to 1:100 and preferably from 100:1 to 1:1 is used. As oxidizing agent, hydrogen peroxide, as well as inorganic peroxides, iodates, bromates, manganese dioxide, permanganates, perchlorates, Cr(IV) compounds, peroxydisulfates, halides and nitric acid, can be used, that is, all oxidizing agents, customary in the art, for the intercalation of sulfuric acid and organic acids, as well as inorganic acids in admixture with organic acids in graphite.

For producing sulfuric acid-graphite particles, a reaction temperature of −10° C. to 100° C. and preferably of 10° C. to 50° C. and a reaction time of 3 minutes to 48 hours can be used. The washing process with the washing liquid, used pursuant to the invention, normally is carried out at a temperature ranging from 0° C. to 90° C. and preferably at a temperature ranging from 10° C. to 50° C. with a residence time of the sulfuric acid-graphite particles in the washing liquid of 10 seconds to 1 hour and preferably of 1 minute to 15 minutes.

In accordance with a preferred embodiment of the invention, the washing liquid contains, as compound affecting the expansion properties of the sulfuric acid-graphite particles, at least one representative of the group comprising sulfates, hydrogen sulfates, sulfites, hydrogen sulfites, nitrates, phosphates, hydrogen phosphates dihydrogen phosphates and acetates of sodium potassium, magnesium, manganese, iron, copper, zinc and aluminum; hydrogen peroxide, iodic acid, bromic acid, permanganic acid, perchloric acid and peroxydisulfuric acid; peroxides, iodates, bromates, permanganates, perchlorates and peroxydisulfates of sodium and potassium; sodium salts of benzenesulfonic acid, 1,3-benzenedisulfonic acid, C₁ to C₃₀ alkylbenzenesulfonic acid, naphthalenesulfonic acid, aromatic and aliphatic aminosulfonic acids, and C₁ to C₃₀ alkylsulfonic acids, sodium C₁ to C₃₀ alkyl sulfates; sodium salts of saturated or unsaturated aliphatic C₂ to C₃₀ carboxylic acids; and saturated or unsaturated, aliphatic, quaternary ammonium salts of formula N(R)4⁺X⁻, in which R independently of one another represents C₁ to C₃₀ alkyl groups and X⁻ represents an anion, in dissolved or dispersed form.

In accordance with a particularly preferred embodiment of the invention, the washing liquid, used for the method, contains the compound, affecting the expansion properties, in a concentration of 10⁻⁵ to 10 moles/L and preferably of 10⁻⁴ to 1 mole/L.

In accordance with an embodiment of the invention, the washing liquid contains, as compound increasing the expansion volume (%/mg) of the sulfuric acid-graphite particles, at least one representative of the group comprising Na₂SO₄, K₂SO₄, MgSO₄, CuSO₄, ZnSO₄, Al₂(SO₄)₃, (NH₄)₂S₂O₈, NaBrO₃, CH₃COONa, NaH₂PO₄, sodium benzenesulfonate, trisodium naphthalenetrisulfonate, sodium 1-butanesulfonate, sodium 1-decanesulfonate, sodium dodecylbenzenesulfonate, sodium toluenesulfonate, tetraethylammonium bromide, decyltrimethylammonium bromide, dodecyltrimethylammonium bromide, tetradecyltrimethylammonium bromide, octadecyltrimethylammonium chloride, sodium acetate, sodium propionate, sodium stearate, sodium oleate and sodium benzoate, in dissolved or dispersed form.

In accordance with a further embodiment of the invention, the washing liquid contains, as compound increasing the expansion rate (%/° C.) of the sulfuric acid-graphite particles in the onset region, at least one representative of the group comprising Na₂SO₄, K₂SO₄, MgSO₄, MnSO₄, CuSO₄, ZnSO₄, Al₂(SO₄)₃, (NH₄)₂S₂O₈, KMnO₄, NaBrO₃, H₂O₂, NaNO₃, NaH₂PO₄, sodium benzenesulfonate, in a concentration of less than 0.0125 moles/L, sodium 1-butanesulfonate, sodium 1-decanesulfonate, sodium dodecylbenzenesulfonate, sodium toluenesulfonate, tetraethylammonium bromide, dodecyltrimethylammonium bromide, octadecyltrimethylammonium chloride, sodium acetate, sodium propionate, sodium stearate, sodium oleate and sodium benzoate, in dissolved or dispersed form.

In accordance with a further embodiment of the invention, the washing liquid contains, as compound increasing the average expansion coefficient (per ° K) of the sulfuric acid-graphite particles, at least one representative of the group comprising Na₂SO₄, K₂SO₄, MgSO₄, MnSO₄, CuSO₄, ZnSO₄, Al₂(SO₄)₃, (NH₄)₂S₂O₈, NaBrO₃, NaH₂PO₄, sodium benzenesulfonate, sodium 1-butanesulfonate, sodium 1-decanesulfonate, sodium toluenesulfonate, tetraethylammonium bromide, decyltrimethylammonium bromide, dodecyltrimethylammonium bromide, tetradecyltriethylammonium bromide, octadecyltrimethylammonium chloride, sodium acetate, sodium propionate, sodium stearate, sodium oleate and sodium benzoate, in dissolved or dispersed form.

In accordance with a further preferred embodiment of the invention, the washing liquid contains as compound, lowering the expansion volume (%/mg) of the sulfuric acid-graphite particles at least one representative of the group comprising MnSO₄, Fe₂SO₄, KMnO₄, H₂O₂, NaNO₃, sodium naphthalenesulfonate, disodium 1,5-naphthalenedisulfonate and sodium caprylate, in dissolved or dispersed form.

In accordance with a further preferred embodiment of the invention, the washing liquid contains as compound, lowering the expansion rate (%/° C.) of the sulfuric acid-graphite particles in the onset range, at least one representative of the group comprising FeSO₄, sodium benzenesulfonate in a concentration of ≧0.0125 moles/L, decyltrimethylammonium bromide, tetradecyltrimethylammonium bromide, sodium naphthalenesulfonate, disodium 1,5-naphthalenedisulfonate, trisodium naphthalenetrisulfonate and sodium caprylate, in dissolved or dispersed form.

In accordance with a further preferred embodiment of the invention, the washing liquid contains, as compound lowering the average expansion coefficient (per ° K) of the sulfuric acid-graphite particles, at least one representative of the group comprising FeSO₄, KMnO₄, H₂O₂, NaNO₃, sodium naphthalenesulfonate, disodium 1,5-naphthalenedisulfonate, trisodium naphthalenetrisulfonate, sodium dodecylbenzenesulfonate and sodium caprylate, in dissolved or dispersed form.

In accordance with a further preferred embodiment of the invention, the graphite particles, reacted with sulfuric acid in the presence of an oxidizing agent, are ground crystalline graphite in the form of particles with a particle size of 0.05 mm to 1 mm and preferably of 0.075 mm to 0.7 mm, the particle size distribution preferably being such that 80% of the graphite particles used have a particles size greater than 0.3 mm, because the expansion properties of the graphite improve with increasing particle size.

Advantageously, the reaction with sulfuric acid is carried out employing a weight ratio of 100 to 300 parts by weight of 95% to 97% and preferably of 96% sulfuric acid per 100 parts by weight of the graphite particles, hydrogen peroxide or nitric acid preferably being used as oxidizing agent. After the reaction, the pH of the graphite particles is about 7, depending on the sulfuric acid concentration employed. Pursuant to the invention, washing is carried out with the aqueous washing liquid, containing the compounds affecting the expansion properties, is carried out up to a pH of 2 to 8, preferably of 3 to 7 and particularly of 3 to 4. The drying is carried out preferably at a temperature ranging from 50° C. to 120° C. up to a residual moisture content of the graphite particles of, preferably, ≦1.5%.

The expansion properties of the sulfuric acid-graphite particles, produced pursuant to the invention, are measured with the help of thermomechanical analysis (TMA). With thermomechanical analysis (TMA), dimensional changes in the sulfuric acid-graphite particles are measured as a function of temperature and time. For this purpose, the sample is placed on a sample carrier and the dimensional change of the sample is measured and recorded with the help of a measuring probe as a function of the heating temperature and the heating time. For this purpose, the powdery sample of sulfuric acid-graphite particles is transferred to a corundum crucible, which is covered with a steel crucible. This steel crucible ensures that, as the sample expands, the dimensional change of the sample is transferred smoothly to the measuring probe, which is in mechanical contact with the upper side of the steel crucible and can be acted upon with an adjustable load.

The following conditions were maintained for determining the expansion behavior using this measuring equipment:

| | |
|---|---|
| Temperature program: | dynamic mode (with prior isothermal phase for |
| | 5 minutes at 25° C.) |
| Heating rate: | 10° C./min |
| Temperature range: | 25° C. to 500° C. |
| Analysis gas: | synthetic air |
| Flow rate: | 50 mL/min |
| Load: | 0.06 N |
| Sample vessel: | 150 μL corundum crucible + 150 μl steel crucible |
| | (as lid) |

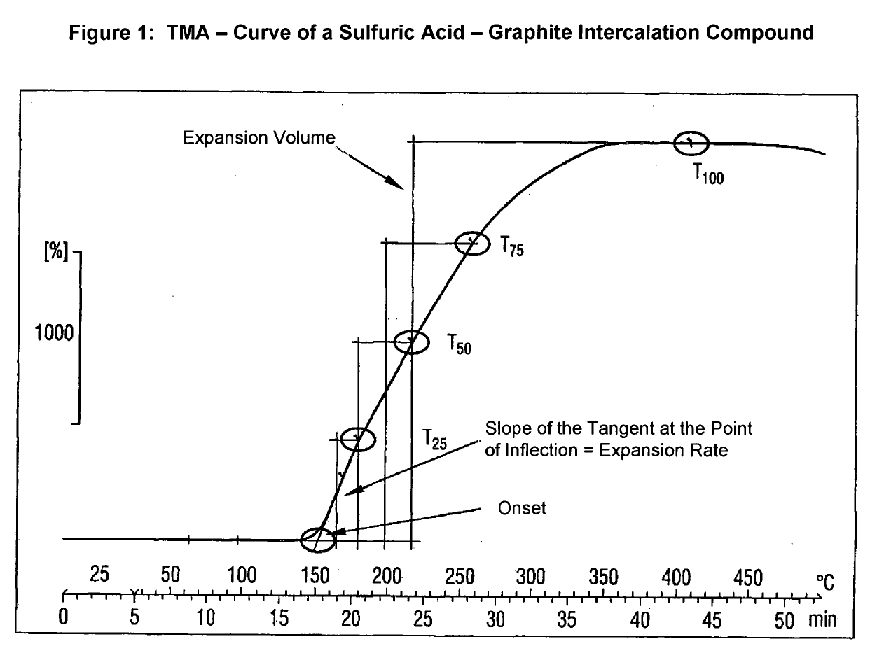

As a result of the thermomechanical analysis, carried out in this way, the TMA curve of a graphite intercalation compound, shown in the attached drawing in FIG. 1, is obtained.

As shown in this FIG. 1, the onset of the sulfuric acid-graphite particles is defined mathematically as the intersection of the baseline before the change in length of the sample and the tangent at the point of inflection of the expansion curve.

The expansion rate of the intumescing material investigated in the area of the onset is equal to the slope of this tangent at the point of inflection. The unit of the expansion rate therefore is (%/° C.).

The expansion volume corresponds to the horizontal step between the baseline and the maximum of the curve. It gives the expansion of the substance (%) or of the starting length Lo. Since the volume in the case of these measurements depends on the sample weight, the expansion volume is standardized to the sample weight. The expansion is therefore stated in units of (%/mg). The values T₂₅, T₅₀, T₇₅ and T₁₀₀ are the temperatures in ° C., at which 25%, 50%, 75% and 100% of the maximum volume has been reached.

As is evident from FIG. 1, the slope of the tangent at the point of inflection only gives information about the initial rate of expansion. A consideration of the average expansion coefficient α in K⁻¹ between the onset and the maximum of the curve (=T₁₀₀) is suitable for representing the whole of the expansion behavior. The average expansion coefficient is defined as

\overline{α}=L₀⁻¹·ΔL·ΔT⁻¹

in which ΔL represents the change in the length of the sample produced by the temperature change ΔT.

All measurements were carried out with graphite samples with comparable particle size distributions ranging from 250 to 400 μm. This was ensured by screening the respective graphite types.

In the following examples, the expansion parameters of the sulfuric acid-graphite particles produced are given as standardized expansion volume, expansion rate in the area of the onset, average expansion coefficient as well as the temperatures T₂₅, T₅₀, T₇₅ and T₁₀₀. In some cases, a multi-step expansion is observed during the measurement. For these cases, the expansion rates in the area of the onset temperatures 1 and 2 (onset 1 or onset 2), as well as the expansion rate between the onset are given.

The following Examples are to explain the invention further.

### EXAMPLE 1

In the following Table, the expansion parameters of two typical commercial expanding graphite types are given.

TABLE 1

| | | Sulfuric |
|---|---|---|
| | Sulfuric | Acid/ |
| | Acid- | Nitric Acid- |
| | Graphite | Graphite |
| Expansion volume relative to sample weight in | 245 | 192 |
| (%/mg) | | |
| T₂₅ in (° C.) | 237 | 219 |
| T₅₀ in (° C.) | 255 | 243 |
| T₇₅ in (° C.) | 278 | 252 |
| T₁₀₀ in (° C.) | 361 | 268 |
| Expansion rate in onset region 1 in (%/° C.) | 8.15 | 12.74 |
| Expansion rate in onset regions 1 and 2 in | — | 3.39 |
| (%/° C.) | | |
| Expansion rate in onset region 2 in (%/° C.) | — | 29.47 |
| Average expansion coefficient between TMA | 0.089 | 0.112 |
| onset 1 and T₁₀₀ per ° K | | |

### EXAMPLE 2

In order to illustrate the ability to adjust the expansion behavior, achieved pursuant to the invention, the following sulfuric acid-graphite particles were produced for comparison and washed only with water as a washing liquid.

The graphite particles, used in this and the following Examples, had a particle size ranging from 0.05 mm to 1 mm, 80% of the particles having a particle size greater than 0.3 mm.

50 g (.42 moles) of graphite particles are transferred into a 100 mL round-bottom flask, mixed with 1.0 mL (0.01 moles) of 30% hydrogen peroxide and 7.5 mL of sulfuric acid (95% to 97%) and stirred at room temperature for 19 hours. Subsequently, the particles are washed with water to a pH of 3 to 4 and dried at 60° C. in a drying oven at 60° C.

On the other hand, the crude sulfuric acid-graphite particles obtained are washed pursuant to the invention, using a washing liquid, which contains metal sulfates, given in the following Table 2, as the compound, which affects the expansion properties, in a concentration in each case of 0.125M, also to a pH of 3 to 4.

The properties of the sulfuric acid-graphite particles, produced in this way, are listed in the following Table 2.

TABLE 2

| | Comparison with | Aqueous 0.125 M solutions | | | |
|---|---|---|---|---|---|
| | water as washing | of the sulfates of: | | | |
| | liquid | Na⁺ | K⁺ | Mg²⁺ | Mn²⁺ |
| Expansion volume relative to | 221 | 338 | 313 | 299 | 103 |
| sample weight in (%/mg) | | | | | |
| T₂₅ in (° C.) | 236 | 232 | 239 | 232 | 449 |
| T₅₀ in (° C.) | 257 | 254 | 262 | 248 | 459 |
| T₇₅ in (° C.) | 287 | 285 | 295 | 266 | 468 |
| T₁₀₀ in (° C.) | 369 | 379 | 392 | 340 | 500 |
| Expansion rate in onset region | 2.33 | 30.21 | 21.68 | 28.24 | 17.62 |
| 1 in (%/° C.) | | | | | |
| Expansion rate in onset | 1.03 | — | — | — | — |
| regions 1 and 2 in (%/° C.) | | | | | |
| Expansion rate in onset region | 14.88 | — | — | — | — |
| 2 in (%/° C.) | | | | | |
| Average expansion coefficient | 0.071 | 0.116 | 0.102 | 0.135 | 0.089 |
| between TMA onset 1 and | | | | | |
| T₁₀₀ per ° K | | | | | |
| | Comparison with | Aqueous 0.125 M solutions | | | |
| | water as washing | of the sulfates of: | | | |
| | liquid | Fe²⁺ | Cu²⁺ | Zn²⁺ | Al³⁺ |
| Expansion volume relative to | 221 | 81 | 276 | 271 | 232 |
| sample weight in (%/mg) | | | | | |
| T₂₅ in (° C.) | 236 | 383 | 246 | 246 | 241 |
| T₅₀ in (° C.) | 257 | 416 | 259 | 261 | 257 |
| T₇₅ in (° C.) | 287 | 442 | 284 | 290 | 280 |
| T₁₀₀ in (° C.) | 369 | 493 | 366 | 366 | 360 |
| Expansion rate in onset region | 2.33 | 0.39 | 29.65 | 30.82 | 20.30 |
| 1 in (%/° C.) | | | | | |
| Expansion rate in onset | 1.03 | 1.89 | — | — | — |
| regions 1 and 2 in (%/° C.) | | | | | |
| Expansion rate in onset region | 14.88 | 5.24 | — | — | — |
| 2 in (%/° C.) | | | | | |
| Average expansion coefficient | 0.071 | 0.013 | 0.116 | 0.112 | 0.096 |
| between TMA onset 1 and | | | | | |
| T₁₀₀ per ° K | | | | | |

It can be inferred from the above Table 2 that the expansion properties of the sulfuric acid-graphite particles obtained can be varied selectively in different directions as a function of the nature of the metal sulfates used in the washing solution and, moreover, as a function of the metal cations. Accordingly, the use of iron(II) sulfate, in comparison to sulfuric acid-graphite washed only with water, leads to a lowering of the expansion rate and of the average expansion coefficient, whereas these properties are increased with the other sulfates.

### EXAMPLE 3

This Example illustrates the effect of the sodium sulfate concentration in the washing liquid on the expansion properties of the sulfuric acid-graphite particles.

For this purpose, 5.0 g (0.42 moles) of the graphite particles, used in the above Examples, are added to a 100 mL round-bottom flask, mixed with 1.0 mL (0.01 moles) of 30% hydrogen peroxide and 7.5 mL of sulfuric acid (95% to 97%) and stirred at room temperature for 19 hours. Subsequently, the particles are washed with an aqueous sodium sulfate solution of concentration varying from 0.0125M to 0.125M to a pH of 3 to 4 and dried at 60° C. in a drying oven.

The expansion properties of the sulfuric acid-graphite particles are summarized in the following Table 3.

TABLE 3

| | Na₂SO₄ | Na₂SO₄ | Na₂SO₄ | |
|---|---|---|---|---|
| | (0.125 | (0.0625 | (0.025 | Na₂SO₄ |
| | M) | M) | M) | (0.0125 M) |
| Expansion volume relative to | 338 | 371 | 331 | 336 |
| sample weight in (%/mg) | | | | |
| T₂₅ in (° C.) | 232 | 226 | 266 | 264 |
| T₅₀ in (° C.) | 254 | 246 | 283 | 279 |
| T₇₅ in (° C.) | 285 | 275 | 317 | 312 |
| T₁₀₀ in (° C.) | 379 | 369 | 396 | 391 |
| Expansion rate in onset region | 30.21 | 30.47 | 36.30 | 39.77 |
| 1 in (%/° C.) | | | | |
| Expansion rate in onset | — | — | — | — |
| regions 1 and 2 in (%/° C.) | | | | |
| Expansion rate in onset region | — | — | — | — |
| 2 in (%/° C.) | | | | |
| Average expansion coefficient | 0.116 | 0.125 | 0.133 | 0.134 |
| between TMA onset 1 and | | | | |
| T₁₀₀ per ° K | | | | |

It is evident from Table 3, that by varying the sodium sulfate concentration in the washing liquid, the expansion properties, particularly the expansion volume, the expansion rate and the average expansion coefficient can be affected selectively.

From the above Table 3, it can be seen, in particular, that the expansion volume is almost independent of the sodium sulfate concentration used, all concentrations leading to an increase in the expansion volume. On the other hand, the expansion rate in the area of the onset decreases as the sodium sulfate concentration increases. The average expansion coefficient behaves similarly. With that, it is readily possible to adjust the expansion rate and the expansion coefficient independently of the expansion volume as a function of the sodium sulfate concentration used.

### EXAMPLE 4

In this Example, sulfuric acid-graphite particles, obtained by the method given in Example 2, are washed with aqueous solutions of oxidizing agents, the concentration of which in each case is 0.05M.

The properties of the sulfuric acid-graphite particles, produced in this way, are summarized in the following Table 4.

TABLE 4

| | (NH₄)₂S₂O₈ | KMnO₄ | NaBrO₃ | H₂O₂ |
|---|---|---|---|---|
| Expansion volume relative to | 297 | 209 | 330 | 153 |
| sample weight in (%/mg) | | | | |
| T₂₅ in (° C.) | 244 | 277 | 261 | 219 |
| T₅₀ in (° C.) | 265 | 312 | 280 | 308 |
| T₇₅ in (° C.) | 302 | 357 | 311 | 365 |
| T₁₀₀ in (° C.) | 365 | 435 | 385 | 430 |
| Expansion rate in onset region | 28.53 | 9.71 | 33.89 | 4.62 |
| 1 in (%/° C.) | | | | |
| Expansion rate in onset | — | 2.12 | — | — |
| regions 1 and 2 in (%/° C.) | | | | |
| Expansion rate in onset region | — | 7.88 | — | — |
| 2 in (%/° C.) | | | | |
| Average expansion coefficient | 0.120 | 0.061 | 0.135 | 0.033 |
| between TMA onset 1 and | | | | |
| T₁₀₀ in per ° K | | | | |

The above Table 4 shows that the expansion behavior of the graphite particles can be varied selectively as a function of the nature of the oxidizing agent used, in that, on the one hand, an increase in the expansion volume, the expansion rate and the average expansion coefficient is caused and, on the other, when potassium permanganate or hydrogen peroxide is used as oxidizing agent, a decrease in these properties is caused.

### EXAMPLE 5

The following Example illustrates the effect of different anions and of cation mixtures in the washing liquid, the compounds, listed in the following Table, in each case being used at a concentration of 0.125M. The properties of the sulfuric acid-graphite particles obtained are summarized in the following Table 5.

TABLE 5

| | | | | Na₂SO₄/ |
|---|---|---|---|---|
| | NaNO₃ | NaOAc | NaH₂PO₄ | ZnSO₄ |
| Expansion volume relative to | 175 | 254 | 328 | 313 |
| sample weight in (%/mg) | | | | |
| T₂₅ in (° C.) | 200 | 247 | 239 | 256 |
| T₅₀ in (° C.) | 274 | 274 | 256 | 283 |
| T₇₅ in (° C.) | 320 | 313 | 289 | 322 |
| T₁₀₀ in (° C.) | 406 | 379 | 379 | 391 |
| Expansion rate in onset region | 28.62 | 17.50 | 30.97 | 34.56 |
| 1 in (%/° C.) | | | | |
| Expansion rate in onset | 0.26 | — | — | — |
| regions 1 and 2 in (%/° C.) | | | | |
| Expansion rate in onset region | 7.03 | — | — | — |
| 2 in (%/° C.) | | | | |
| Average expansion coefficient | 0.046 | 0.094 | 0.117 | 0.118 |
| between TMA onset 1 and | | | | |
| T₁₀₀ per ° K | | | | |

From the above Table, it can be seen that, when sodium nitrate is used as compound affecting the expansion properties, a decrease in the expansion volume and in the average expansion coefficient can be obtained while, at the same time, the expansion rate is increased in comparison to the sulfuric acid-graphite, washed only with water.

### EXAMPLE 6

This Example illustrates the effect of aromatic sulfonates in the washing liquid, the sulfonates being used in each case at a concentration of 0.125M.

The results obtained are summarized in the following Table 6.

TABLE 6

| | | | Disodium | |
|---|---|---|---|---|
| | Sodium | Sodium | 1,5- | Trisodium |
| | benzenesulfonate | naphthalenesulfonate | naphthalenedisulfonate | naphthalenetrisulfonate |
| Expansion volume relative to | 332 | 121 | 181 | 282 |
| sample weight in (%/mg) | | | | |
| T₂₅ in (° C.) | 241 | 258 | 272 | 243 |
| T₅₀ in (° C.) | 282 | 345 | 339 | 300 |
| T₇₅ in (° C.) | 335 | 393 | 378 | 349 |
| T₁₀₀ in (° C.) | 424 | 462 | 437 | 445 |
| Expansion rate in onset | 1.30 | 0.55 | 1.30 | 2.32 |
| region 1 in (%/° C.) | | | | |
| Expansion rate in onset | 1.30 | — | — | — |
| regions 1 and 2 in (%/° C.) | | | | |
| Expansion rate in onset | 19.03 | — | — | — |
| region 2 in (%/° C.) | | | | |
| Average expansion | 0.083 | 0.020 | 0.038 | 0.060 |
| coefficient between TMA | | | | |
| onset 1 and T₁₀₀ per ° K | | | | |

In the above Table, it can be seen that sodium naphthalenesulfonate, disodium 1,5-naphthalenedisulfonate and trisodium methylenetrisulfonate are suitable for achieving a lower average expansion coefficient, the expansion volumes and expansion rates varying.

### EXAMPLE 7

This example illustrates the effect of sodium benzenesulfonate concentration in the washing liquid on the expansion properties of the sulfuric acid-graphite particles obtained.

For this purpose, 5.0 g (0.42 moles) of graphite particles of the same particle size as in the preceding Examples are added are transferred into a 100 mL round-bottom flask, mixed with 1.0 mL (0.01 moles) of 30% hydrogen peroxide and 7.5 mL of sulfuric acid (95% to 97%) and stirred at room temperature for 19 hours. Subsequently, the particles are washed with a diluted solution of sodiumbenzene sulfonate with concentration varying from 0.001 M to 0.125 M to a pH of 3 to 4 and dried at 60° C. in a drying oven.

The properties of the graphite particles obtained are listed in the following Table 7.

TABLE 7

| | Sodium | Sodium | Sodium | Sodium | Sodium |
|---|---|---|---|---|---|
| | benzene- | benzene- | benzene- | benzene- | benzene- |
| | sulfonate | sulfonate | sulfonate | sulfonate | sulfonate |
| | (0.125 M) | (0.0625 M) | (0.025 M) | (0.0125 M) | (0.001 M) |
| Expansion volume relative | 332 | 400 | 374 | 372 | 305 |
| to sample weight in | | | | | |
| (%/mg) | | | | | |
| T₂₅ in (° C.) | 241 | 252 | 253 | 239 | 248 |
| T₅₀ in (° C.) | 282 | 288 | 289 | 266 | 262 |
| T₇₅ in (° C.) | 335 | 338 | 330 | 308 | 295 |
| T₁₀₀ in (° C.) | 424 | 421 | 406 | 389 | 368 |
| Expansion rate in onset | 1.30 | 18.71 | 20.94 | 26.30 | 34.09 |
| region 1 in (%/° C.) | | | | | |
| Expansion rate in onset | 1.30 | — | — | — | — |
| regions 1 and 2 in (%/° C.) | | | | | |
| Expansion rate in onset | 19.03 | — | — | — | — |
| region 2 in (%/° C.) | | | | | |
| Average expansion | 0.083 | 0.114 | 0.117 | 0.123 | 0.128 |
| coefficient between TMA | | | | | |
| onset 1 and T₁₀₀ per ° K | | | | | |

It can be inferred from Table 7 that, with sodium benzenesulfonate at a concentration of 0.001M to 0.0625M, a clear increase in the expansion volume, the expansion rate and the average expansion coefficient can be achieved in comparison with the graphite particles washed only with water. When sodium benzenesulfonate is used at a concentration of 0.125M, the same properties result. However, the expansion rate is somewhat lower in the area of the onset.

The above data of Table 7 shows that the highest expansion volume is achieved at a concentration of 0.0625M. The expansion rate and average expansion coefficient also decrease as the sodium benzenesulfonate concentration increases. Furthermore, it can be seen that the achievable expansion volume, the expansion rate in the onset area and the average expansion coefficient decrease with increasing chain length.

### EXAMPLE 8

This Example illustrates the effect of aliphatic and aromatic sulfonates at a concentration of 0.0625M in the washing liquid.

For preparing the sulfuric acid-graphite particles, 5.0 g (0.42 moles) of graphite particles of the same particle size as in the preceding examples are transferred into a 100 mL round-bottom flask, mixed with 1.0 mL (0.01 moles) of 30% hydrogen peroxide and 7.5 mL of sulfuric acid (95% to 97%) and stirred at room temperature for 19 hours. Subsequently, the particles are washed with a diluted sulfonate solution with concentration of 0.0625 M to a pH of 3 to 4 and dried at 60° C. in a drying oven.

The properties of the sulfuric acid-graphite particles obtained are given in the following Table 8.

TABLE 8

| | Sodium 1- | Sodium 1- | Sodium | Sodium |
|---|---|---|---|---|
| | butanesulfonate | decanesulfonate | dodecylbenzenesulfonate | toluenesulfonate |
| Expansion volume relative to | 434 | 502 | 269 | 378 |
| sample weight in (%/mg) | | | | |
| T₂₅ in (° C.) | 238 | 239 | 232 | 248 |
| T₅₀ in (° C.) | 265 | 271 | 274 | 294 |
| T₇₅ in (° C.) | 306 | 312 | 328 | 333 |
| T₁₀₀ in (° C.) | 387 | 401 | 415 | 412 |
| Expansion rate in onset region | 36.47 | 26.29 | 4.56 | 15.00 |
| 1 in (%/° C.) | | | | |
| Expansion rate in onset | — | — | 2.12 | — |
| regions 1 and 2 in (%/° C.) | | | | |
| Expansion rate in onset region | — | — | 10.21 | — |
| 2 in (%/° C.) | | | | |
| Average expansion coefficient | 0.146 | 0.149 | 0.058 | 0.107 |
| between TMA onset 1 and | | | | |
| T₁₀₀ per ° K | | | | |

It can be inferred from the above Table that, with the sulfonates given, an increase in the expansion volume, the expansion rate and, with the exception of sodium dodecylbenzenesulfate, also in the average expansion coefficient can always be attained in comparison with the sulfuric acid-graphite washed only with water.

### EXAMPLE 9

This Example illustrates the effect of cationic surfactants with an ammonium head, which are used at a concentration of 1.0×10⁻³M in the washing liquid.

The following Table 9 shows the expansion properties of the sulfuric acid-graphite particles, which were obtained using these washing liquids and employing the procedure of the preceding Examples.

TABLE 9

| | Tetra- | Decyl- | Dodecyl- | Tetradecyl- | Octadecyl- |
|---|---|---|---|---|---|
| | EA-BR | TMA-Br | TMA-Br | TMA-Br | TMA-Cl |
| Expansion volume relative to | 321 | 312 | 321 | 304 | 300 |
| sample weight in | | | | | |
| (%/mg) | | | | | |
| T₂₅ in (° C.) | 257 | 233 | 241 | 238 | 244 |
| T₅₀ in (° C.) | 288 | 253 | 266 | 270 | 275 |
| T₇₅ in (° C.) | 325 | 288 | 302 | 308 | 318 |
| T₁₀₀ in (° C.) | 382 | 368 | 373 | 384 | 380 |
| Expansion rate in onset | 19.15 | 1.18 | 26.74 | 1.53 | 26.42 |
| region 1 in (%/° C.) | | | | | |
| Expansion rate in onset | — | 1.18 | — | 1.53 | — |
| regions 1 and 2 in (%/° C.) | | | | | |
| Expansion rate in onset | — | 27.44 | — | 17.91 | — |
| region 2 in (%/° C.) | | | | | |
| Average expansion | 0.120 | 0.105 | 0.119 | 0.077 | 0.111 |
| coefficient between TMA | | | | | |
| onset 1 and T₁₀₀ per ° K | | | | | |

EA = ethylammonium,
TMA = trimethylammonium

It can be inferred from the above Table 9 that, in comparison to the sulfuric acid-graphite particles washed only with water, a clear increase in the expansion volume and in the average expansion coefficient can be achieved, whereas the expansion rates can be varied as a function of the cationic surfactants used.

### EXAMPLE 10

This Example illustrates the effect of using anionic surfactants with a carboxylic acid head as compounds for affecting the expansion behavior. These anionic surfactants are used at a concentration of 0.125M.

TABLE 10

| | Sodium | Sodium | Sodium | Sodium | Sodium | Sodium |
|---|---|---|---|---|---|---|
| | acetate | propionate | caprylate | stearate | oleate | benzoate |
| | 0.125 M | 0.125 M | 0.125 M | 1.6 × 10⁻³ M | 8.0 × 10⁻⁴ M | 0.0625 M |
| Expansion volume | 254 | 308 | 179 | 375 | 326 | 383 |
| relative to sample | | | | | | |
| weight in (%/mg) | | | | | | |
| T₂₅ in (° C.) | 247 | 245 | 354 | 230 | 236 | 249 |
| T₅₀ in (° C.) | 274 | 278 | 384 | 257 | 261 | 291 |
| T₇₅ in (° C.) | 313 | 323 | 407 | 297 | 294 | 338 |
| T₁₀₀ in (° C.) | 379 | 402 | 459 | 379 | 370 | 443 |
| Expansion rate in | 17.50 | 17.94 | 1.71 | 6.71 | 26.97 | 15.35 |
| onset region 1 in | | | | | | |
| (%/° C.) | | | | | | |
| Expansion rate in | — | — | — | 6.71 | — | — |
| onset regions 1 and | | | | | | |
| 2 in (%/° C.) | | | | | | |
| Expansion rate in | — | — | — | 21.74 | — | — |
| onset region 2 in | | | | | | |
| (%/° C.) | | | | | | |
| Average expansion | 0.094 | 0.095 | 0.049 | 0.113 | 0.120 | 0.093 |
| coefficient between | | | | | | |
| TMA onset 1 and | | | | | | |
| T₁₀₀ per ° K | | | | | | |

This Table also illustrates that the expansion behavior of the sulfuric acid-graphite particles can be controlled selectively by using the anionic surfactants employed in the washing liquid.

The above Examples show that, with the help of the inventive method, it is readily possible, by varying the compounds, used in the washing liquid employed and affecting the expansion behavior, or by varying their concentration, to vary the expansion properties of the sulfuric acid-graphite particles obtained and, with that, to optimize them with regard to their use as intumescing fire-retarding additives for producing fire-retarding compositions.

1. A method for controlling the expansion properties of thermally expandable sulfuric acid-graphite particles, wherein the sulfuric acid-graphite particles, produced by the reaction of graphite particles with sulfuric acid in the presence of an oxidizing agent, washed with an aqueous washing liquid, containing the compounds affecting the expansion properties, to a pH ranging from 2 to 8, measured in the washing liquid separated from the washed sulfuric acid-graphite particles, and then dried.

2. The method of claim 1, wherein the sulfuric acid-graphite prticles are washed with an aqueous washing liquid, containing the compounds affecting the expansion properties, to a pH ranging from 3 to 7.

3. The method of claim 1, wherein the washing liquid contains, as compound affecting the expansion properties of the sulfuric acid-graphite particles, at least one representative of the group comprising sulfates, hydrogen sulfates, sulfites, hydrogen sulfites, nitrates, phosphates, hydrogen phosphates dihydrogen phosphates and acetates of sodium, potassium, magnesium, manganese, iron, copper, zinc and aluminum; hydrogen peroxide, iodic acid, bromic acid, permanganic acid, perchloric acid and peroxydisulfuric acid; peroxides, iodates, bromates, permanganates, perchlorates and peroxydisulfates of sodium and potassium; sodium salts of benzenesulfonic acid, 1,3-benzenedisulfonic acid, C₁ to C₃₀ alkylbenzenesulfonic acid, naphthalenesulfonic acid, aromatic and aliphatic aminosulfonic acids, and C₁ to C₃₀ alkylsulfonic acids, sodium C₁ to C₃₀ alkyl sulfates; sodium salts of saturated or unsaturated aliphatic C₂ to C₃₀ carboxylic acids; and saturated or unsaturated, aliphatic, quaternary ammonium salts of formula N(R)4⁺X⁻, in which R independently of one another represents C₁ to C₃₀ alkyl groups and X⁻ represents an anion, in dissolved or dispersed form.

4. The method of claim 1, wherein the washing liquid contains the compound, affecting the expansion properties, in a concentration of 10⁻⁵ to 10 moles/L and preferably of 10⁻⁴ to 1 mole/L.

5. The method of claim 1, wherein the washing liquid contains, as compound increasing the expansion volume (%/mg) of the sulfuric acid-graphite particles, at least one representative of the group comprising Na₂SO₄, K₂SO₄, MgSO₄, CuSO₄, ZnSO₄, Al₂(SO₄)₃, (NH₄)₂S₂O₈, NaBrO₃, CH₃COONa, NaH₂PO₄, sodium benzenesulfonate, trisodium naphthalenetrisulfonate, sodium 1-butanesulfonate, sodium 1-decanesulfonate, sodium dodecylbenzenesulfonate, sodium toluenesulfonate, tetraethylammonium bromide, decyltrimethylammonium bromide, dodecyltrimethylammonium bromide, tetradecyltrimethylammonium bromide, octadecyltrimethylammonium chloride, sodium acetate, sodium propionate, sodium stearate, sodium oleate and sodium benzoate, in dissolved or dispersed form.

6. The method of claim 1, wherein the washing liquid contains, as compound increasing the expansion rate (%/° C.) of the sulfuric acid-graphite particles in the onset region, at least one representative of the group comprising Na₂SO₄, K₂SO₄, MgSO₄, MnSO₄, CuSO₄, ZnSO₄, Al₂(SO₄)₃, (NH₄)₂S₂O₈, KMnO₄, NaBrO₃, H₂O₂, NaNO₃, NaH₂PO₄, sodium benzenesulfonate, in a concentration of less than 0.0125 moles/L, sodium 1-butanesulfonate, sodium 1-decanesulfonate, sodium dodecylbenzenesulfonate, sodium toluenesulfonate, tetraethylaammonium bromide, dodecyltrimethylammonium bromide, octadecyltrimethylammonium chloride, sodium acetate, sodium propionate, sodium stearate, sodium oleate and sodium benzoate, in dissolved or dispersed form.

7. The method of claim 1, wherein the washing liquid contains, as compound increasing the average expansion coefficient (per ° K) of the sulfuric acid-graphite particles, at least one representative of the group comprising Na₂SO₄, K₂SO₄, MgSO₄, MnSO₄, CuSO₄, ZnSO₄, Al₂(SO₄)₃, (NH₄)₂S₂O₈, NaBrO₃, NaH₂PO₄, sodium benzenesulfonate, sodium 1-butanesulfonate, sodium 1-decanesulfonate, sodium toluenesulfonate, tetraethylammonium bromide, decyltrimethylammonium bromide, dodecyltrimethylammonium bromide, tetradecyltriethylammonium bromide, octadecyltrimethylammonium chloride, sodium acetate, sodium propionate, sodium stearate, sodium oleate and sodium benzoate, in dissolved or dispersed form.

8. The method of claim 1, wherein the washing liquid contains as compound, lowering the expansion volume (%/mg) of the sulfuric acid-graphite particles at least one representative of the group comprising MnSO₄, Fe₂SO₄, KMnO₄, H₂O₂, NaNO₃, sodium naphthalenesulfonate, disodium 1,5-naphthalenesulfonate and sodium caprylate, in dissolved or dispersed form.

9. The method of claim 1, wherein the washing liquid contains as compound, lowering the expansion rate (%/° C.) of the sulfuric acid-graphite particles in the onset range, at least one representative of the group comprising FeSO₄, sodium benzenesulfonate in a concentration of ≧0.0125 moles/L, decyltrimethylammonium bromide, tetradecyltrimethylammonium bromide, sodium naphthalenesulfonate, disodium 1,5-naphthalenedisulfonate, trisodium naphthalenetrisulfonate and sodium caprylate, in dissolved or dispersed form.

10. The method of claim 1, wherein the washing liquid contains, as compound lowering the average expansion coefficient (per ° K) of the sulfuric acid-graphite particles, at least one representative of the group comprising FeSO₄, KMnO₄, H₂O₂, NaNO₃, sodium naphthalenesulfonate, disodium 1,5-naphthalenedisulfonate, trisodium naphthalenetrisulfonate, sodium dodecylbenzenesulfonate and sodium caprylate, in dissolved or dispersed form.

11. Intumescing fire-retarding additives for producing fire-retarding compositions for sealing wall bushings and other openings in walls, floors and ceilings of buildings, comprising thermally expandable sulfuric acid-graphite particles, produced by the reaction of graphite particles with sulfuric acid in the presence of an oxidizing agent, washed with an aqueous washing liquid, containing the compounds affecting the expansion properties, to a pH ranging from 2to 8 measured in the washing liquid separated from the washed sulfuric acid-graphite particles, and then dried.
